(19) United States
(12) Patent Application Publication
(10) Pub. No.: US 2015/0294169 A1
(43) Pub. Date: Oct. 15, 2015

(54) VEHICLE VISION SYSTEM WITH DRIVER MONITORING

(71) Applicant: MAGNA ELECTRONICS INC., Auburn Hills, MI (US)

(72) Inventors: Yong Zhou, Etobicoke (CA); Diego Ghinaudo, Bagnolo Piemonte (IT)

(21) Appl. No.: 14/675,926

(22) Filed: Apr. 1, 2015

Related U.S. Application Data
(60) Provisional application No. 62/018,867, filed on Jun. 30, 2014.
(60) Provisional application No. 62/010,597, filed on Jun. 11, 2014.
(60) Provisional application No. 61/989,652, filed on May 7, 2014.
(60) Provisional application No. 61/977,940, filed on Apr. 10, 2014.

(51) Int. Cl. G06K 9/00; G06F 3/01; H04N 5/225; B60W 40/08

(52) U.S. Cl. CPC G06K 9/00845; B60W 40/08; G06F 3/013; G06F 3/012; H04N 5/2256

(57) ABSTRACT

A vision system of a vehicle includes a camera and a control. The camera is disposed in the vehicle and has a field of view encompassing a portion of a windshield of the vehicle. The control includes an image processor operable to process image data captured by the camera. The control, responsive to processing of captured image data by the image processor, is operable to determine a driver's head and eyes and gaze direction via reflection at the windshield of the vehicle. The vision system may include an illumination source that emits illumination towards the windshield to enhance determination of the driver's head and eyes and gaze direction. The control, responsive to processing of captured image data by the image processor, may be operable to determine precipitation at the windshield.

### CROSS REFERENCE TO RELATED APPLICATIONS

The present application is related to U.S. provisional applications, Ser. No. 62/018,867, filed Jun. 30, 2014, Ser. No. 62/010,597, filed Jun. 11, 2014, Ser. No. 61/989,652, filed May 7, 2014, and Ser. No. 61/977,940, filed Apr. 10, 2014, which are hereby incorporated herein by reference in their entireties.

### FIELD OF THE INVENTION

The present invention relates generally to a vehicle vision system for a vehicle and, more particularly, to a vehicle vision system that utilizes one or more cameras at a vehicle and that is operable to determine a driver's head position and/or viewing direction or gaze.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a vision system or imaging system for a vehicle that utilizes one or more cameras (preferably one or more CMOS cameras) to capture image data representative of the driver's head and eyes to determine a gaze direction of the driver. The camera is disposed in the dashboard of the vehicle and views the windshield of the vehicle, whereby the driver's head and eyes are imaged via reflection off of or at the windshield, such as off of or at the in-cabin surface of the windshield. An illumination source, such as an infrared illumination source, may be provided to enhance detection of the driver's head and eyes. Optionally, the camera (that detects or images the driver's gaze) may also be part of a rain sensing function or system of the vehicle for detecting rain drops or precipitation at the windshield, such as at the outer surface of the windshield.

The optical path between the camera and the driver's eyes thus includes a generally vertical portion between the camera and the windshield and a generally horizontal or longitudinal portion between the windshield and the driver's eyes, with the generally horizontal or longitudinal portion of the optical path passing over the steering wheel of the vehicle and being substantially unobstructed by the steering wheel and/or the driver's arm(s) during normal operation of the vehicle by the driver. Thus, the present invention positions the camera in a manner such that all the driver/in cabin monitoring applications can be developed and operated without the fear of the driver (such as the driver's arms at the steering wheel of the vehicle) blocking the camera's view of the driver's face, especially during crucial times such as during a turning maneuver. Optionally, the system of the present invention may detect the driver's gaze with the same camera that is used to detect water drops or rain or precipitation on the windshield, such as reflected by the infrared light that may also be used to illuminate the driver via reflection off of or at the windshield.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a perspective view showing a driver gaze camera disposed at a steering wheel of a vehicle;

FIG. 3 is a perspective view showing two driver gaze cameras disposed at an instrument panel of a vehicle;

FIG. 4 is a plan view of the cameras and instrument panel of FIG. 3;

FIG. 5 is a side elevation of a driver gaze system of the present invention;

FIG. 6 is a side elevation similar to FIG. 5, showing a comparison between the driver gaze system of the present invention and a driver gaze system with the camera at the instrument panel or steering wheel;

FIG. 7 is a side elevation of a driver gaze system of the present invention, showing use of the driver's gaze and precipitation cameras pointing at the windshield as a rain sensor;

FIG. 8 is a perspective view of an interior cabin monitoring system of the present invention, shown with a camera disposed at the roof of the vehicle cabin for capturing images of the front and rear seating area of the vehicle; and

FIG. 9 is an image captured by the camera of FIG. 8.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

Referring now to the drawings and the illustrative embodiments depicted therein, a vehicle 10 includes an imaging system or vision system that includes a camera 22 disposed at a dashboard of the vehicle and having a field of view that encompasses a region of the windshield 24 generally above the camera. The camera captures image data representative of that region of the windshield, and via reflection at the windshield, captures image data representative of the driver's head and eyes. An image processor is operable to process image data captured by the camera 22 to determine the gaze direction of the driver, as discussed below. The system may utilize aspects of the systems described in U.S. Pat. No. 7,914,187 and/or U.S. patent applications, Ser. No. 14/623,690, filed Feb. 17, 2015 (Attorney Docket MAGO4 P-2457); and/or Ser. No. 14/272,834, filed May 8, 2014 (Attorney Docket MAGO4 P-2278), which are hereby incorporated herein by reference in their entireties.

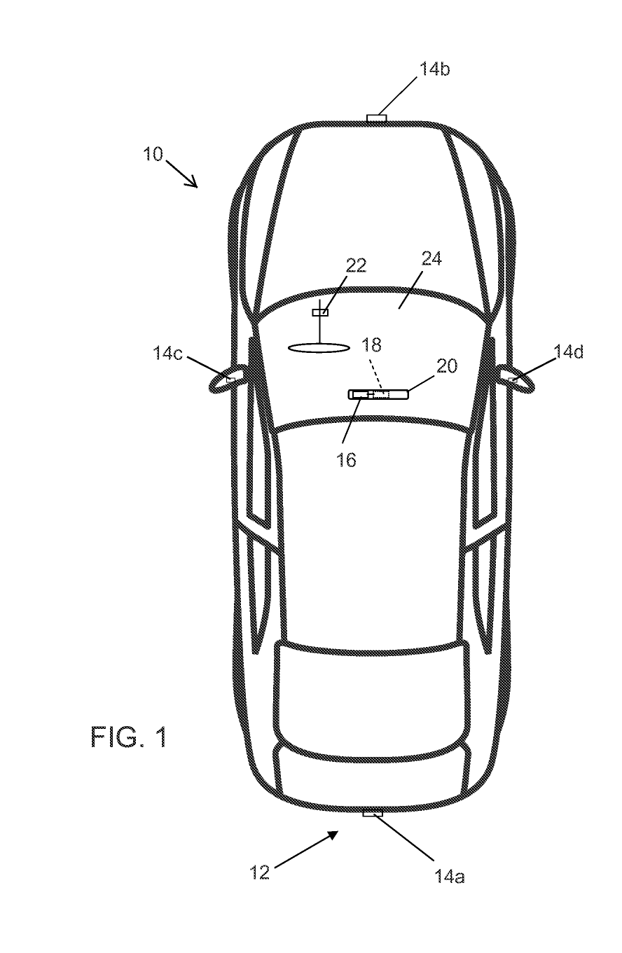

Optionally, a vision system 12 of the vehicle 10 may include at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

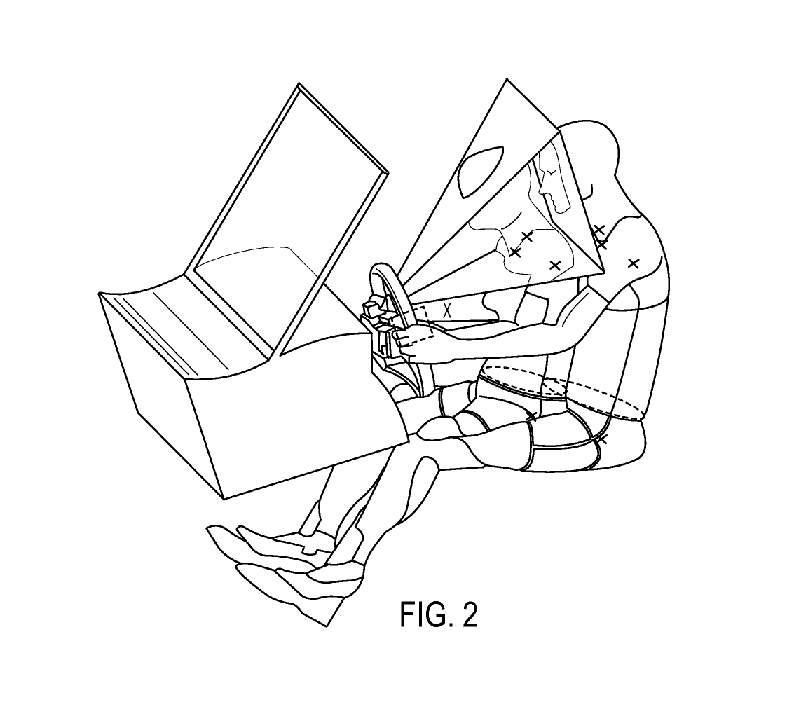

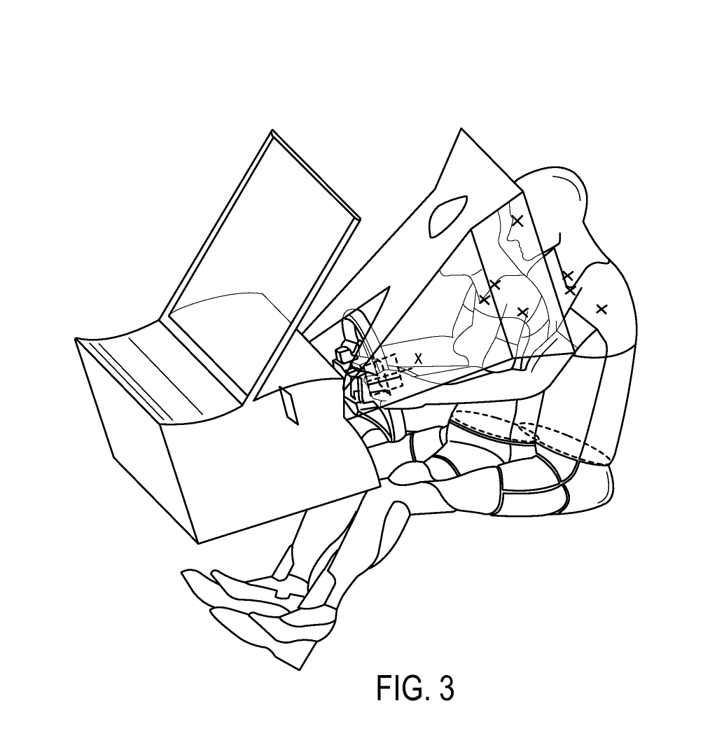

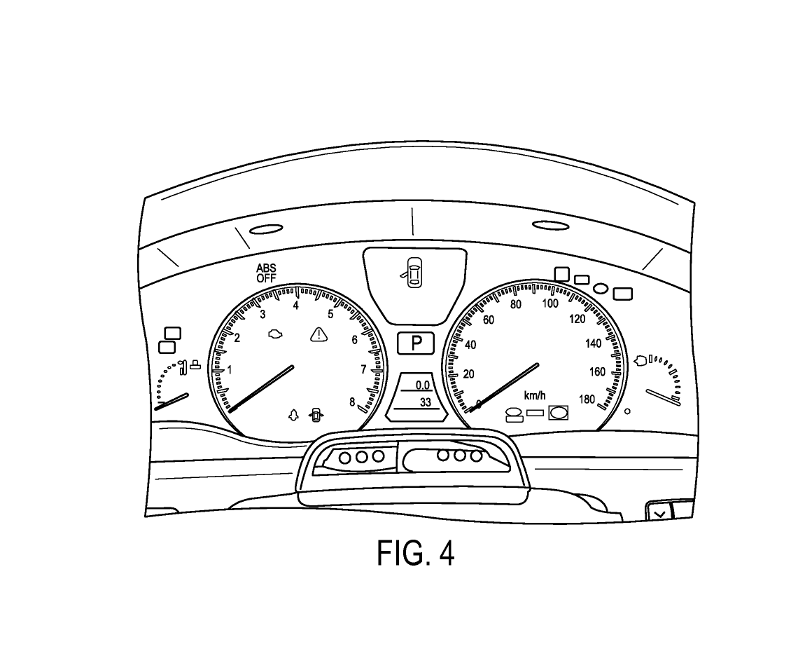

As shown in FIGS. 2-4, when a system has the driver head monitoring camera at an instrument panel and behind a steering wheel (FIG. 2) or two driver head monitoring cameras at an instrument panel and behind a steering wheel (FIGS. 3 and 4), the driver's arm and/or steering wheel may block the camera's view of the driver's head and eyes.

For example, and such as shown in FIGS. 2-4, the driver's arm and steering wheel may frequently move into and out of the field of view and region of interest (ROI) of the field of view of the camera during normal operation of the vehicle. The arm and steering wheel not only block the view of the driver's face which is ROI of the driver gaze algorithm (that processes the captured image data to determine the driver's gaze), it also make the sensor exposure control difficult. Whenever the ROI is blocked, the algorithm has no image to process and may lose the tracking of the features. Once the blockage (e.g., the driver's arms or the vehicle steering wheel) moves out of the way, the camera will still take few frames to stabilize. The algorithm may also take time to re-track and reclassify the features. Thus, in such a configuration (with the camera viewing through the region typically occupied by the steering wheel and/or driver's arms) the gaze and face detection function will be intermittent and not very feasible.

The issue with the ICI application of conventional systems is that the working range of the camera inside the working envelope is much larger than the degrees of freedom (DOF). The camera working range inside the working envelope is the three dimensional (3D) projection of the working envelope onto the optical axis of camera. For example, this working range may be about 70 cm, which is considerably more than the 14 cm DOF of a typical system.

The illumination or light level of the camera's view can change several times across the working range. It is also blocked by the driver's arm and steering wheel from time to time. It can also be blocked by a sun visor for passenger application or the like. The correct exposure level is difficult to achieve. If an auto exposure mode is selected, the image may be in oscillation and also the ROI exposure may not be at an optimized range. If a manual exposure control is selected, the system may have difficulties in having appropriate exposure across the working range. Some areas may be saturated and other areas may be under exposed, which makes the ROI in that range dark and noisy.

Thus, the present invention provides a driver gaze camera or monitoring system that captures image data representative of the driver's eyes and gaze direction via an optical path that does not pass through or encompass the steering wheel and/or the driver's arms during normal operation of the vehicle by the driver.

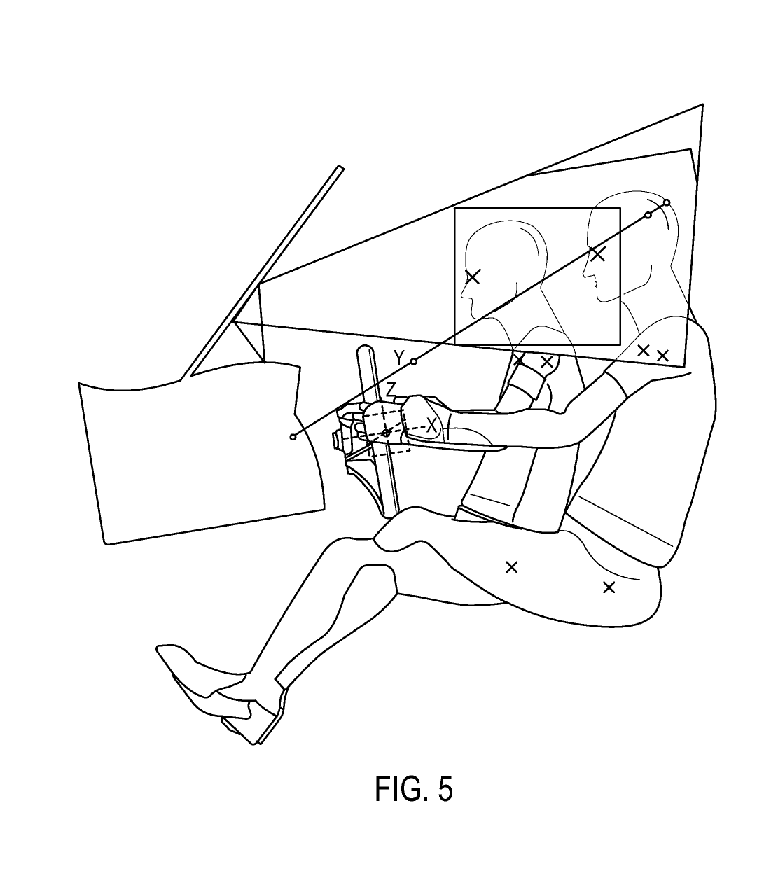

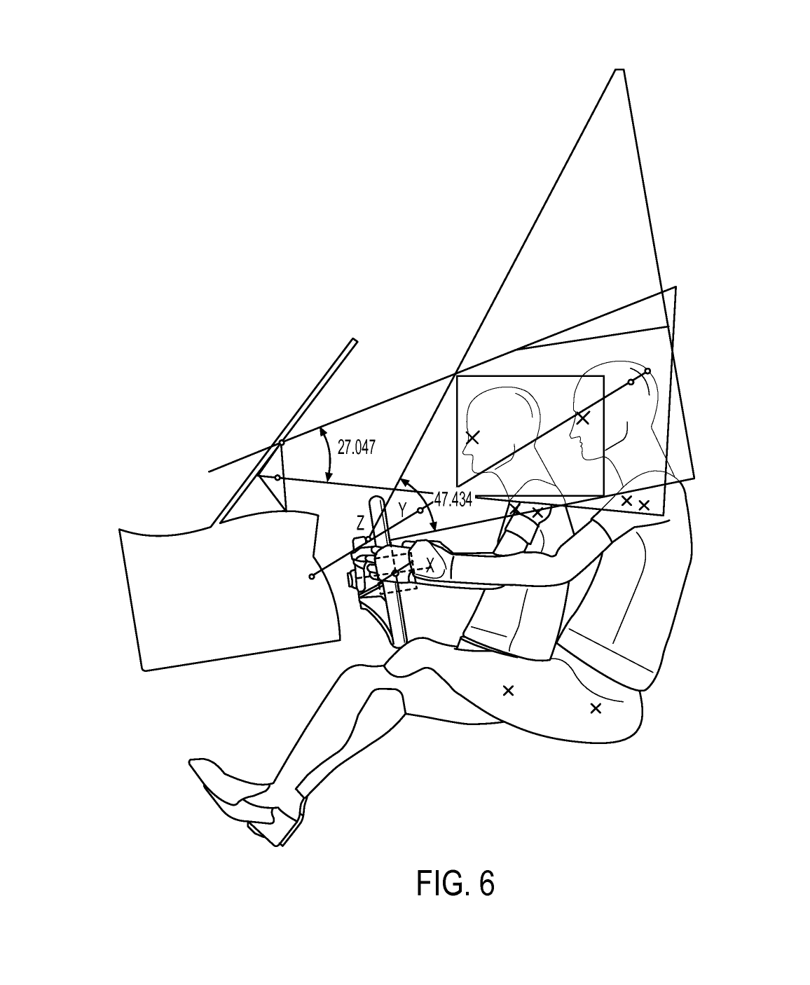

The system of the present invention has one or more cameras and one or more light sources mounted at or in or on the vehicle dash board. The camera has its field of view generally upward towards a region of the windshield and captures driver or passenger images reflected from the windshield (see FIG. 5). The illumination source or light source (such as an infrared or near-infrared illumination source or IR or near IR light emitting diode (LED) or the like) may provide illumination (such as IR Illumination) that may illuminate the driver directly when mounted at, on top of or in the near of the steering column (such as shown in FIG. 6) or the illumination may be reflected from the windshield towards the driver or passenger when mounted on top of the dashboard and close to the driver or passenger gaze camera or cameras. The virtual camera optical axis follows the driver's or passenger's direction of view or gaze direction.

The driver monitoring system may be combined with the assembly of a dash board head up display. The head up display may be a light field monitor based 3D vision head up display, such as a display utilizing aspects of U.S. provisional application Ser. No. 62/113,556, filed Feb. 9, 2015. Optionally, a combiner head up display may be used. The monitoring system according to the present invention may be used for tracking the head and eyes of the driver for controlling the light field.

Optionally, the windshield may include a partially reflective coating or layer to enhance reflectivity at the region of the windshield that is encompassed by the camera's field of view. For example, a partially reflective but substantially visible light transmissive metallic thin film layer may be disposed at the in-cabin surface of the windshield at the viewed region of the windshield to enhance reflectivity at the region while not affecting or substantially not affecting viewability by the driver through the windshield. Such thin film coatings or layers may be similar to the types used in vehicle rearview mirror reflective elements, such as the types described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are all hereby incorporated herein by reference in their entireties.

Thus, the system of the present invention provides advantages over other gaze detection systems. For example, with the present invention, there is no camera ROI blockage at normal vehicle operation conditions, which guarantees or enhances continuous classification and tracking the features. Also, because the illumination reflects off of the windshield, the illumination does not pass through the region where the steering wheel and driver's arms may be so there is no illumination blockage, which provides enhanced illumination uniformity. Also, the illumination power or intensity requirement may be reduced due to the smaller FOV that is to be illuminated. Also, the present invention provides a reduced or minimal DOF requirement. The ROI appears larger in the FOV, which lowers the sensor resolution and hardware computational power requirements. The system of the present invention can handle applications in driver and passenger monitoring and/or seat occupation monitoring, and can be used in airbag and headrest adjustment and pre-crash control, seat position adjustment control and seat anti-squeeze control and/or the like.

The camera and illumination source of the present invention are directed towards the windshield to capture image data representative of the driver's head and gaze direction. Optionally, the camera or another camera or two or more cameras may capture image data representative of reflection of a passenger's head and gaze or of other regions of interest interior of the vehicle. For example, two cameras may be disposed in the vehicle and in front of the driver, such as disposed at opposite sides of a vertical plan along and through the steering column axis, such that the cameras view generally upwardly and are angled towards the driver's face reflection from opposite sides. The captured data may be processed for determination of the driver's or passenger's eye gaze direction and focus distance and/or for other applications or functions, such as for use in association with activation of a display or the like, such as by utilizing aspects of the systems described in U.S. patent application Ser. No. 14/623,690, filed Feb. 17, 2015 (Attorney Docket MAGO4 P-2457), which is hereby incorporated herein by reference in its entirety. The system may utilize suitable processing techniques to determine the eye gaze, such as by utilizing aspects of the systems described in U.S. patent application Ser. No. ______, filed Apr. 1, 2015 by Wacquant and Rachor (Attorney Docket MAG04 P-2493), which is hereby incorporated herein by reference in its entirety.

Optionally, the present invention may provide an interior monitoring system that determines when an occupant or occupants (such as a small child or baby) or animal is left in a vehicle after the driver has left the vehicle, and that, responsive to such a determination, generates an alert to the driver and/or to others to alert the driver and others of a potential serious health hazard to the child left in the vehicle. Often, some parents forget their young children inside their vehicle and do not arrive in time to save their lives. Such unfortunate events occur several times each year.

The monitoring and alert system of the present invention may use vision system and camera technology (such as described above) to monitor and determining what is happening in the back seats of the vehicle, such as when or after the driver has left the parked vehicle. The system may utilize a camera and/or an infrared sensor and may be disposed inside the vehicle near the rear view mirror or at the center of the vehicle roof or headliner so that the system may monitor and check what happens in the rear seats of the vehicle at any given moment. The system may utilize classification methods for object and occupant classification, such as described International Publication No. WO 2008/106804, which is hereby incorporated herein by reference in its entirety.

Optionally, the system may use additional vehicle inherent sensors and data such as in cabin temperature sensors, the climate control's status data (such as for vehicles where the climate control works even when the vehicle is parked), electrical window position (closed or open or partially open) status data, fire or smoke sensors, rain sensor data and/or the like. Optionally, additional live surveillance sensors may be used such as terahertz wave sensors for surveying and monitoring the health conditions of the rear seat occupant or occupants. Optionally, an in cabin acoustical sensor, such as microphones or the like, may be used for detecting when the occupant (such as a small child or baby) or animal (such as a dog) is crying or barking or otherwise making sounds or noise.

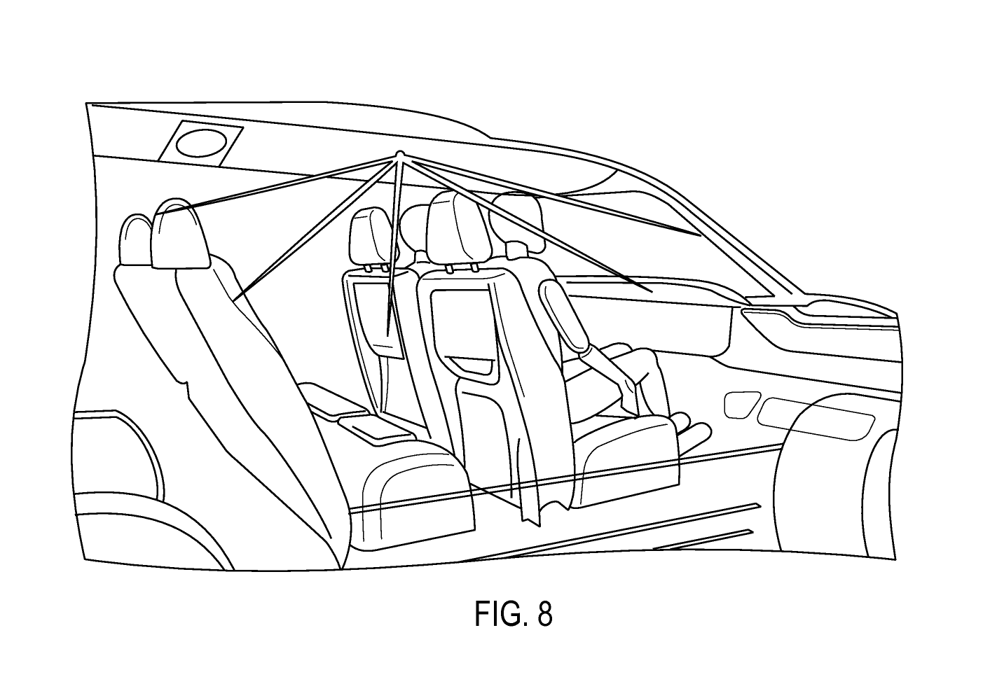

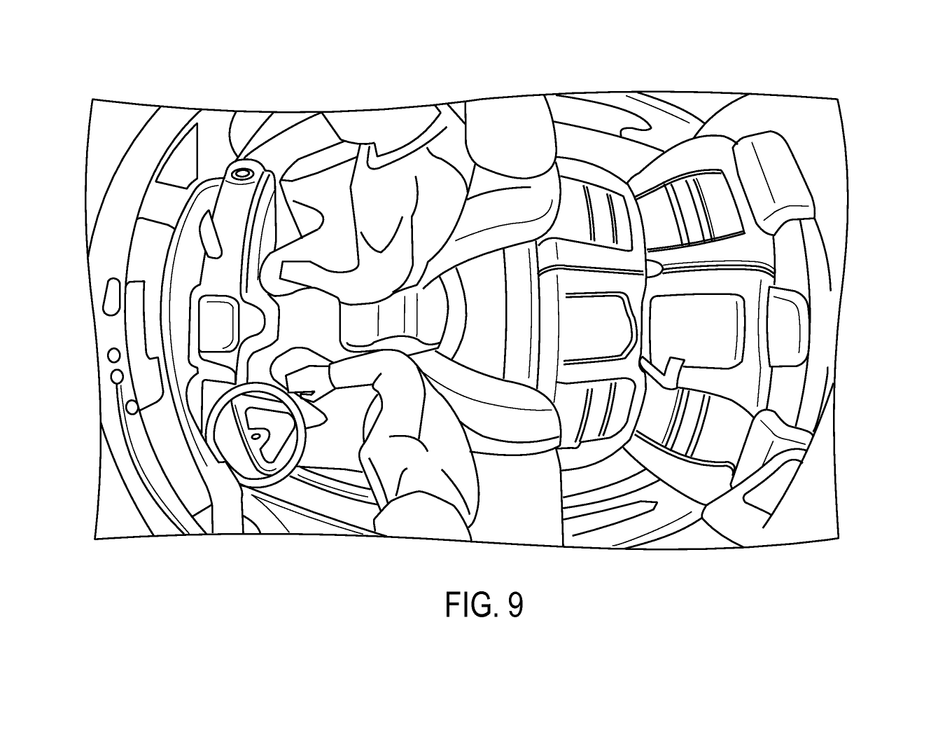

For example, the cabin monitoring system may include a camera at the roof of the vehicle (such as shown in FIG. 8), whereby the camera captures images of both the front and rear seating areas, such as shown in FIG. 9. Thus, a roof-mounted camera may capture images of all 5 seats or seating locations of a typical vehicle (two front seats and three rear seats), which provides for full cabin occupant sensing for occupant detection (and child in rear seat detection) and intrusion security. The cabin monitoring system thus monitors all seats of the vehicle without use of individual sensors at the seats. When an occupant is detected (or if a crash or intrusion is detected), the system may output one or more captured images and optionally additional vehicle sensor data such as discussed above, such as via a telematics system of the vehicle (such as ONSTAR® or the like), to a remote service provider or to a recording device (such as a “black box” type of recording device of the vehicle), such as by utilizing aspects of the systems described in U.S. patent application Ser. No. 14/169,329, filed Jan. 31, 2014 (Attorney Docket MAG04 P-2218), which is hereby incorporated herein by reference in its entirety, or to a mobile device (such as to the vehicle owner's smart phone or mobile device or the like) or to a keyfob or the like associated with the vehicle. Optionally, the images may be output to the mobile device and/or keyfob when selected by the user (such as an image-on-demand option for the user to select so that the images are communicated to the user's mobile device). Optionally, acoustical or audio data or sound information may be transmitted as well for providing a type of baby phone/monitor function (for parents) optionally combined with visual data or health parameter information.

When the driver of the vehicle parks the vehicle and turns off the engine, the controller may process captured image data (captured by the interior monitoring or rearward viewing interior camera) to determine if there is anyone (person or animal) present in the rear seats of the vehicle. If the system determines that there is someone in the rear seat, the system may generate or activate an alarm, such as after a predetermined time period has elapsed after a triggering event, such as when the driver has shut off the vehicle and/or left the vehicle (closed and locked the vehicle doors). For example, the system may generate the alarm after about one minute, or maybe after about five minutes following the triggering event (to allow for time for the driver to leave the car and get the child out of the vehicle, whereby if the elapsed time is greater than this and the child is still in the vehicle, the system may determine that the child was left in the vehicle by the driver).

Optionally, before entering a state of an active alarm, the system may lower the vehicle's electrical windows automatically for a selected or predetermined distance to increase the (passive) air exchange in the vehicle and/or may activate an HVAC climate control system of the vehicle (for vehicles having such a system that is operable when the vehicle is parked with the ignition off). This state or mode may be entered when the temperature is above a certain threshold and was determined to be rising over a duration of time (such as, for example, at least two minutes or more), and when the rain sensor does not detect that it is raining outside of the vehicle. Another benefit of lowering the windows may be that arriving help (if not the driver or owner of the vehicle and thus without keys to the vehicle) may be able to readily enter the vehicle.

Responsive to such a determination, the system may generate two kinds of alarms. A first alarm or alert may comprise an audible alarm (such as the vehicle horn or security alarm or the like) and the second alarm or alert may comprise a telephone call made by the vehicle telematics system or the like. For example, the system may automatically dial and call one or more preselected or input phone numbers of the system. Optionally, the system may send or text or email photographs or still images (captured by the monitoring camera) of the rear seat region (and occupant thereat) directly to the phone numbers of the mobile telephones input into the system. If there is no answer or response to the alerts, the system may then call an emergency number, such as 9-1-1 or the local police department, fire department or ambulance telephone number(s) or the like. That way, in case nobody answers the other alerts, the police will be notified and will arrive to open the vehicle. Optionally, visual information and/or health parameter information may be transmitted to the ambulance or police as well. Optionally, there may be a master key or remote master key function applied which enables the police, fire service or ambulance personnel to open the vehicle automatically and quickly when a critical alarm state or mode of the occupant surveillance system is reached, and eventually this comes in combination with or as part of a vehicle anti-theft and surveillance system, such as shown in the above referenced and incorporated U.S. patent application Ser. No. 14/169,329, filed Jan. 31, 2014 (Attorney Docket MAG04 P-2218).

The system of the present invention may also monitor the rear seat of the vehicle during normal driving of the vehicle, and may be selectively operable (such as responsive to a user input) to display the captured images (such as at a video mirror display or an in-dash display screen or the like), so that the driver of the can view the images of the rear seat area (and occupant(s) thereat) at any time without turning his or her head and neck and losing control of the vehicle.

Optionally, the system of the present invention may be operable to generate alerts (such as via mobile phone communications or the telematics system or the like) to assist people in case of a vehicle collision or accident. For example, the system, responsive to a determination that the ignition is switched to off or responsive to a determination of a vehicle collision or the like, may generate the communication alerts, such as following a time period after the ignition is off and with occupants still detected in the vehicle.

Since the system of the present invention employs in cabin cameras capturing the driver's and passenger's faces, the system may have an optional vanity or make-up mirror function. Instead of looking into a real vanity mirror (typically disposed at a sun visor of the vehicle), the driver or passenger (optionally at any seat) may get his or her face displayed in a display in front of the person or nearby the person (such as at a central location at the vehicle dashboard or the like, when engaging the vanity mirror function. Optionally, the driver's or passenger's face may be displayed in a mirrored way (by reversing the image so that the person, when viewing the displayed images of his or her face, is viewing the images as if they were a reflection at a mirror).

The system of the present invention may be installed in the vehicle by the vehicle manufacturer during the vehicle assembly, or may be provided and installed as an aftermarket kit (that may provide an interior monitoring camera and control circuitry that may connect to the vehicle systems or accessories). The aftermarket system may be connected to the systems or accessories (such as the horn or security system, the ignition, the door lock control and the telematics system) of the vehicle, such as via a network bus connection.

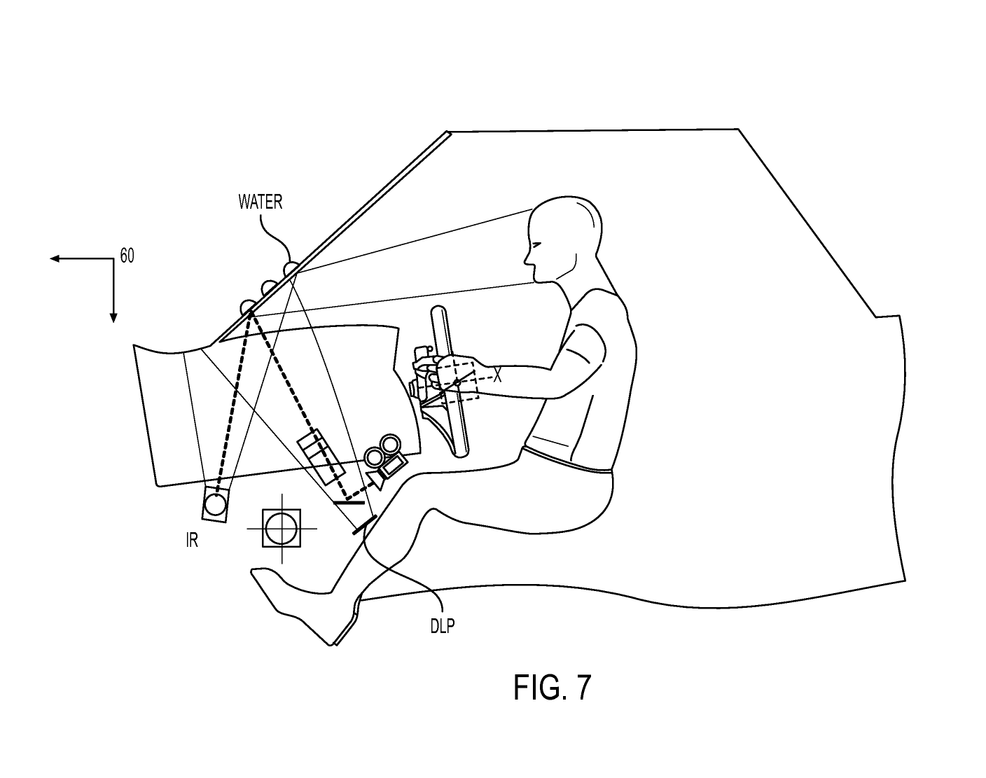

As another aspect of the invention, the eye gaze cameras may be dually used for a different purpose. For example, due to the cameras pointing to the windshield, one portion of the collected or captured image may come from a reflection from the windshield and another portion of the collected or captured image may come from outside the windshield. Because rain drops present on the windshield's outside surface affect (refract and reflect) ambient light (from outside the vehicle) differently than a plain or clean windshield surface, raindrops are visible to or discernible by the (eye gaze-) cameras (see FIG. 7). The rain drops may be detected by utilizing an algorithm of the type described in U.S. patent application Ser. No. 14/183,613, filed Feb. 19, 2014 (Attorney Docket MAG04 P-2225), which is hereby incorporated herein by reference in its entirety. By detecting the raindrops by the eye gaze cameras, the system of the present invention may enable replacement of conventional (single use) rain sensors typically installed in or at the windshield area, consuming valuable space.

Thus, the system of the present invention may be readily installed in any vehicle and may then provide the safety function to limit or mitigate the possibility of a child or baby being unintentionally left in the vehicle when the driver or parent parks and exits the vehicle.

The cameras or sensors of the systems of the present invention may comprise any suitable cameras or sensors. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 201 2/1 581 67; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661; WO 2013/158592 and/or WO 2014/204794, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Publication No. US-2012-0062743, which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454; and/or 6,824,281, and/or International Publication Nos. WO 2010/099416; WO 2011/028686; and/or WO 2013/016409, and/or U.S. Pat. Publication No. US 2010-0020170, and/or U.S. patent application Ser. No. 13/534,657, filed Jun. 27, 2012 (Attorney Docket MAGO4 P-1892), which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. Pat. Nos. 8,542,451; 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580 and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. Nos. 7,255,451 and/or 7,480,149, and/or U.S. Publication No. US-2006-0061008 and/or U.S. patent application Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. Publication No. US-2012/012427, which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249; and/or WO 2013/109869, and/or U.S. Publication No. US-2012/012427, which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. Publication Nos. US-2006-0061008 and/or US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036 and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742 and/or 6,124,886, and/or U.S. Publication No. US-2006-0050018, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera disposed in a vehicle and having a field of view encompassing a portion of a windshield of the vehicle;
a control having an image processor operable to process image data captured by said camera; and
wherein said control, responsive to processing of captured image data by said image processor, is operable to determine a driver's head and eyes and gaze direction via reflection of the driver's head and eyes off a surface of the windshield of the vehicle.

2. The vision system of claim 1, wherein an optical path between said camera and the driver's eyes has a generally vertical portion between said camera and the windshield and a generally horizontal portion between the windshield and the driver's eyes.

3. The vision system of claim 2, wherein the generally horizontal portion of the optical path is above a steering wheel of the vehicle.

4. The vision system of claim 1, wherein said camera is disposed at or above a steering column of the vehicle and having a field of view generally upwardly towards the windshield of the vehicle.

5. The vision system of claim 4, wherein an optical path between said camera and the driver's eyes passes over the steering wheel of the vehicle and is substantially unobstructed by the steering wheel and the driver's arms during normal operation of the vehicle by the driver.

6. The vision system of claim 1, comprising an illumination source that emits illumination towards the windshield to enhance determination of the driver's head and eyes and gaze direction.

7. The vision system of claim 6, wherein said illumination source comprises an infrared light emitting illumination source.

8. The vision system of claim 6, wherein said control, responsive to processing of captured image data by said image processor, is operable to determine precipitation at an outer surface of the windshield.

9. The vision system of claim 1, wherein said control, responsive to processing of captured image data by said image processor, is operable to determine precipitation at an outer surface of the windshield.

10. The vision system of claim 1, comprising a second camera disposed in the vehicle and having a second field of view encompassing the portion of the windshield.

11. The vision system of claim 10, wherein said camera and said second camera are disposed at opposite sides of a plane along a steering column axis and wherein the portion of the windshield is generally centered over the steering column axis, and wherein said camera and said second camera are angled towards the portion of the windshield.

12. A vision system of a vehicle, said vision system comprising:
a camera disposed in a vehicle and having a field of view encompassing a portion of a windshield of the vehicle;
wherein an optical path between said camera and the driver's eyes has a generally vertical portion between said camera and the portion of the windshield and a generally horizontal portion between the portion of the windshield and the driver's eyes;
a control having an image processor operable to process image data captured by said camera;
an illumination source that, when activated, emits illumination towards the portion of the windshield;
wherein said camera is operable to capture image data at least when said illumination source is activated; and
wherein said control, responsive to processing of captured image data by said image processor, is operable to determine a driver's head and eyes and gaze direction via reflection of the driver's head and eyes off a surface of the windshield of the vehicle.

13. The vision system of claim 12, wherein the generally horizontal portion of the optical path is above a steering wheel of the vehicle.

14. The vision system of claim 12, wherein said camera is disposed at or above a steering column of the vehicle and having a field of view generally upwardly towards the windshield of the vehicle, and wherein an optical path between said camera and the driver's eyes passes over the steering wheel of the vehicle and is substantially unobstructed by the steering wheel and the driver's arms during normal operation of the vehicle by the driver.

15. The vision system of claim 12, wherein said illumination source comprises an infrared light emitting illumination source.

16. The vision system of claim 12, wherein said control, responsive to processing of captured image data by said image processor, is operable to determine precipitation at an outer surface of the windshield.

17. The vision system of claim 12, comprising a second camera disposed in the vehicle and having a second field of view encompassing the portion of the windshield, and wherein said camera and said second camera are disposed at opposite sides of a plane along a steering column axis and wherein the portion of the windshield is generally centered over the steering column axis, and wherein said camera and said second camera are angled towards the portion of the windshield.

18. A vision system of a vehicle, said vision system comprising:
a camera disposed in a vehicle and having a field of view encompassing a portion of a windshield of the vehicle;
a control having an image processor operable to process image data captured by said camera;
an illumination source that, when activated, emits illumination towards the portion of the windshield, wherein said illumination source comprises an infrared light emitting illumination source;
wherein said camera is operable to capture image data at least when said illumination source is activated;
wherein said control, responsive to processing of captured image data by said image processor, is operable to determine a driver's head and eyes and gaze direction via reflection of the driver's head and eyes off a surface of the windshield of the vehicle; and
wherein said control, responsive to processing of captured image data by said image processor, is operable to determine precipitation at an outer surface of the windshield.

19. The vision system of claim 18, wherein said camera is disposed at or above a steering column of the vehicle and having a field of view generally upwardly towards the windshield of the vehicle, and wherein an optical path between said camera and the driver's eyes passes over the steering wheel of the vehicle and is substantially unobstructed by the steering wheel and the driver's arms during normal operation of the vehicle by the driver.

20. The vision system of claim 18, comprising a second camera disposed in the vehicle and having a second field of view encompassing the portion of the windshield, and wherein said camera and said second camera are disposed at opposite sides of a vertical plane along a steering column axis and wherein the portion of the windshield is generally centered over the steering column axis, and wherein said camera and said second camera are angled towards the portion of the windshield.
